(19) United States
(12) Patent Application Publication
(10) Pub. No.: US 2020/0207304 A1
(43) Pub. Date: Jul. 2, 2020

(54) HOOD SUPPORT STRUCTURE

(71) Applicant: HONDA MOTOR CO., LTD., Tokyo (JP)

(72) Inventors: Kazutada Sasaki, Wako-shi (JP); Shin Saeki, Wako-shi (JP)

(21) Appl. No.: 16/709,081

(22) Filed: Dec. 10, 2019

(30) Foreign Application Priority Data
Dec. 28, 2018 (JP) 2018-247921

(51) Int. Cl. B60R 21/38; B62D 25/12; E05D 11/00

(52) U.S. Cl. CPC B60R 21/38; B62D 25/12; E05D 2011/009; E05Y 2900/536; E05D 11/00

(57) ABSTRACT

A hood support structure includes a hood configured to close an opening section of a vehicle body, a hinge member that includes a pedestal section fixed to a lower surface of the hood, a support section attached pivotably with respect to the vehicle body, and a deformation section which is provided between the pedestal section and the support section and which is fragile than the pedestal section and the support section, and an actuator that has a shaft configured to slide out in a predetermined direction, and that is configured to move the hood upward from the opening section by abutting a tip portion of the shaft with the deformation section, wherein a receiving section into which the tip portion of the shaft enters is provided in the deformation section.

### CROSS-REFERENCE TO RELATED APPLICATION

Priority is claimed on Japanese Patent Application No. 2018-247921, filed Dec. 28, 2018, the content of which is incorporated herein by reference.

### BACKGROUND OF THE INVENTION

### Field of the Invention

The present invention relates to a hood support structure.

### Description of Related Art

In the related art, a pop-up hood apparatus (hereinafter, a hood support structure) configured to lift up a hood provided on a front section of a vehicle body is known. In such a hood support structure, when an impact load is input to the vehicle body, an actuator provided in the vehicle body is actuated to lift up the hood.

For example, Japanese Unexamined Patent Application, First Publication No. 2015-150926 discloses a hood support structure including a hood having a concave section for engagement on a lower surface thereof, and an actuator having an engaging section engaged with the concave section for engagement. According to the technology disclosed in Japanese Unexamined Patent Application, First Publication No. 2015-150926, in a state in which the engaging section is engaged with the concave section for engagement and displacement of the engaging section with respect to the concave section for engagement is restricted, the hood can be moved from a closed position to a lifted position as the engaging section moves to a side above a vehicle.

### SUMMARY OF THE INVENTION

However, in a case the technology disclosed in Japanese Unexamined Patent Application, First Publication No. 2015-150926 is applied to the hood support structure in which the hood and the vehicle body are connected by a deformable hinge member and configured to lift up the hood by deforming the hinge member, a relative position between the hinge member and the actuator easily changes. For this reason, in the technology disclosed in Japanese Unexamined Patent Application, First Publication No. 2015-150926, transmission efficiency of a force from the actuator to the hinge member may be decreased and a deformation state of the hinge member may become unstable. Accordingly, there is room for improvement in terms of providing a hood support structure capable of stabilizing deformation of a hinge member and reliably operating a hood.

An aspect of the present invention is directed to providing a hood support structure capable of stabilizing deformation of a hinge member and reliably operating a hood.

(1) A hood support structure according to an aspect of the present invention includes a hood configured to close an opening section of a vehicle body; a hinge member that includes a pedestal section fixed to a lower surface of the hood, a support section attached pivotably with respect to the vehicle body, and a deformation section which is provided between the pedestal section and the support section and which is fragile than the pedestal section and the support section; and an actuator that has a shaft configured to slide out in a predetermined direction, and that is configured to move the hood upward from the opening section by abutting a tip portion of the shaft with the deformation section, wherein a receiving section into which the tip portion of the shaft enters is provided in the deformation section.

(2) In the aspect of the above-mentioned (1), the receiving section may be a plate member provided to overlap the deformation section on the side of the hood, and rigidity of the receiving section may be higher than rigidity of the deformation section.

(3) In the aspect of the above-mentioned (1), the receiving section may be provided integrally with the hinge member, and rigidity of the receiving section may be higher than rigidity of the deformation section.

(4) In the aspect of any one of the above-mentioned (1) to (3), the tip portion of the shaft may have a convex surface, and the receiving section may have a concave surface having a curvature corresponding to the tip portion of the shaft and recessed toward the hood.

(5) In the aspect of any one of the above-mentioned (1) to (3), a hole into which the tip portion of the shaft enters may be formed in the receiving section.

(6) In the aspect of the above-mentioned (5), the hole may be a long hole having a major axis in a forward/rearward direction of the vehicle body.

(7) In the aspect of the above-mentioned (5), the hole may be formed as a perfect circle.

(8) In the aspect of any one of the above-mentioned (1) to (7), the actuator may be supported pivotably with respect to the vehicle body while following movement of the hood.

According to the above-mentioned (1), the hood is moved upward as the actuator abuts the hinge member. Accordingly, since a cavity is provided between the hood and engine parts provided on a front section of the vehicle body, when a colliding body collides with the front section of the vehicle body, a collision load of the colliding body input to the vehicle body can be absorbed by deformation of the hood. Here, the hinge member moves the hood upward by being pivoted upward by the actuator and the deformation section being deformed. Since the tip portion of the shaft abuts the deformation section of the hinge member, input from the actuator can be concentrated on a deformation center, and the deformation section can be reliably deformed. Accordingly, a moving amount of the hood can be accurately controlled with respect to a target value.

Since the receiving section is provided on the deformation section, an abutting position between the tip portion of the actuator during extension and the hinge member that is pivoted can be constantly maintained by fitting the tip portion of the shaft into the receiving section. Accordingly, occurrence of friction can be suppressed by the tip portion of the shaft sliding of the hinge member, and output of the shaft can be efficiently transmitted to the deformation section.

Accordingly, it is possible to provide the hood support structure capable of stabilizing deformation of the hinge member and reliably operating the hood.

Further, since the output of the actuator can be efficiently converted into deformation of the deformation section, output of the actuator can be minimized. Accordingly, saving of energy and reduction in costs due to reduction in size and a decrease in output of the actuator can be achieved.

According to the aspect of the above-mentioned (2), the receiving section is formed by providing the plate member on the deformation section, and rigidity of the receiving section is higher than that of the deformation section. Accordingly, a force from the actuator can be reliably received by the receiving section, and output of the actuator can be efficiently transmitted to the deformation section.

Accordingly, it is possible to provide the hood support structure capable of stabilizing deformation of the hinge member and reliably operating the hood.

According to the aspect of the above-mentioned (3), since the receiving section is provided integrally with the hinge member, the number of parts can be reduced in comparison with the case in which the receiving section is formed as a separate member. In addition, since rigidity of the receiving section is higher than that of the deformation section, a force from the actuator can be reliably received by the receiving section, and output of the actuator can be efficiently transmitted to the deformation section.

Accordingly, the hood can be reliably operated by a simple configuration.

According to the aspect of the above-mentioned (4), since the convex surface and the concave surface are fitted with each other, an abutting position between the tip portion of the shaft and the receiving section can be constantly held. Accordingly, the tip portion of the shaft can reliably follow the hinge member that is pivoted, and the hood can be reliably moved to a target position of the hood.

According to the aspect of the above-mentioned (5), since the tip portion of the shaft is fitted into the hole of the receiving section, the tip portion of the shaft can be received. In this way, since the receiving section can be provided in a simple configuration, it is possible to provide the hood support structure in which machining of the receiving section during manufacturing is easy.

According to the aspect of the above-mentioned (6), the major axis of the long hole is formed in the forward/rearward direction of the vehicle body. Accordingly, in comparison with the case in which the receiving section is formed by the circular hole, slippage between the tip portion of the shaft and the receiving section is allowed which is caused by the pivoting of the hinge member and the movement of the deformation section in the forward/rearward direction. Accordingly, removal of the tip portion of the shaft from the hinge member during pivoting of the hinge member can be minimized. Accordingly, output of the actuator can be stably transmitted to the deformation section.

According to the aspect of the above-mentioned (7), since the hole is formed as a perfect circle, the tip portion of the shaft is reliably fitted into the hole. Accordingly, variation of a relative position between the hinge member and the tip portion of the shaft can be minimized. Accordingly, a force from the actuator can be reliably received by the receiving section, and output of the actuator can be more efficiently transmitted to the deformation section.

According to the aspect of the above-mentioned (8), since the actuator is supported pivotably with respect to the vehicle body, the actuator is inclined rearward while following movement of the hood. Accordingly, even during the pivoting of the hinge member, the receiving section and the tip portion of the shaft can abut each other. In addition, since the actuator is also pivoted while following rearward movement of the receiving section, deformation of the shaft can be minimized. Accordingly, output of the actuator can be stably transmitted to the deformation section, and the hood can be reliably operated.

### BRIEF DESCRIPTION OF THE DRAWINGS

FIG. 1 is a perspective view showing a vehicle body front section when a hood support structure in a vehicle body according to an embodiment is operated.

FIG. 2 is a side view showing the vehicle body front section when the hood support structure in the vehicle body according to the embodiment is operated.

FIG. 3 is a side view of a hinge member and an actuator in a first state and a second state according to a first embodiment.

FIG. 4 is a plan view of the hinge member in the first state according to the first embodiment.

FIG. 5 is a perspective view of a receiving section according to the first embodiment.

FIG. 6 is a cross-sectional view of a receiving section according to a first variant of the first embodiment.

FIG. 7 is a cross-sectional view of a receiving section according to a second variant of the first embodiment.

FIG. 8 is a cross-sectional view of a receiving section according to the second embodiment.

FIG. 9 is a plan view of the receiving section according to the second embodiment.

FIG. 10 is a cross-sectional view of a receiving section according to a first variant of the second embodiment.

FIG. 11 is a plan view of a receiving section according to a second variant of the second embodiment.

### DETAILED DESCRIPTION OF THE INVENTION

Hereinafter, embodiments of the present invention will be described with reference to the accompanying drawings. Further, in the following description, directions will be described based on directions of forward, rearward, leftward, rightward, upward and downward as seen by a driver.

### First Embodiment

### (Hood Support Structure)

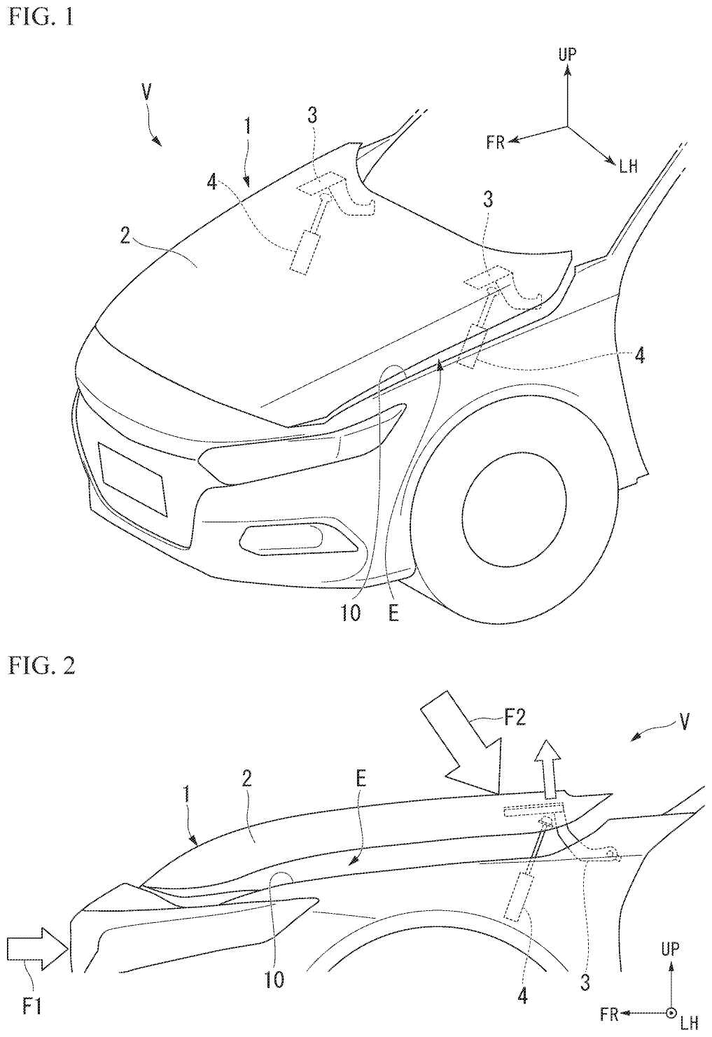

FIG. 1 is a perspective view showing a front section of a vehicle body V when a hood support structure 1 is operated. FIG. 2 is a side view of the front section of the vehicle body V from a left side in a vehicle width direction upon operation of the hood support structure 1.

The vehicle body V is a vehicle body of an automobile including a driving source such as an engine, a motor, or the like, in a front section, a trunk room, or the like, (neither is shown). The vehicle body V includes the hood support structure 1 in the front section. The hood support structure 1 is operated by receiving a signal from a G sensor (not shown) installed on a front bumper when an impact load F1 is input to the front bumper from a side in front of the vehicle body V, for example, during travel. The hood support structure 1 includes a hood 2, hinge members 3, and actuators 4.

### (Hood)

The hood 2 is provided at the front of the vehicle body V. In a state in which the hood support structure 1 is not operated, the hood 2 closes an opening section 10 of an accommodating space E for an engine or the like provided in the front of the vehicle body V. Parts such as an engine or the like which are not shown (hereinafter referred to as internal parts) are accommodated in the accommodating space E. When the impact load F1 is input to the front of the vehicle body V and the hood support structure 1 is operated, the hood 2 slides toward the rear of the vehicle body V while the entire hood 2 moves upward with respect to the vehicle body V. In this way, when the hood 2 is moved upward and rearward, a predetermined gap is secured between the internal parts accommodated in the accommodating space E and the hood 2.

### (Hinge Member)

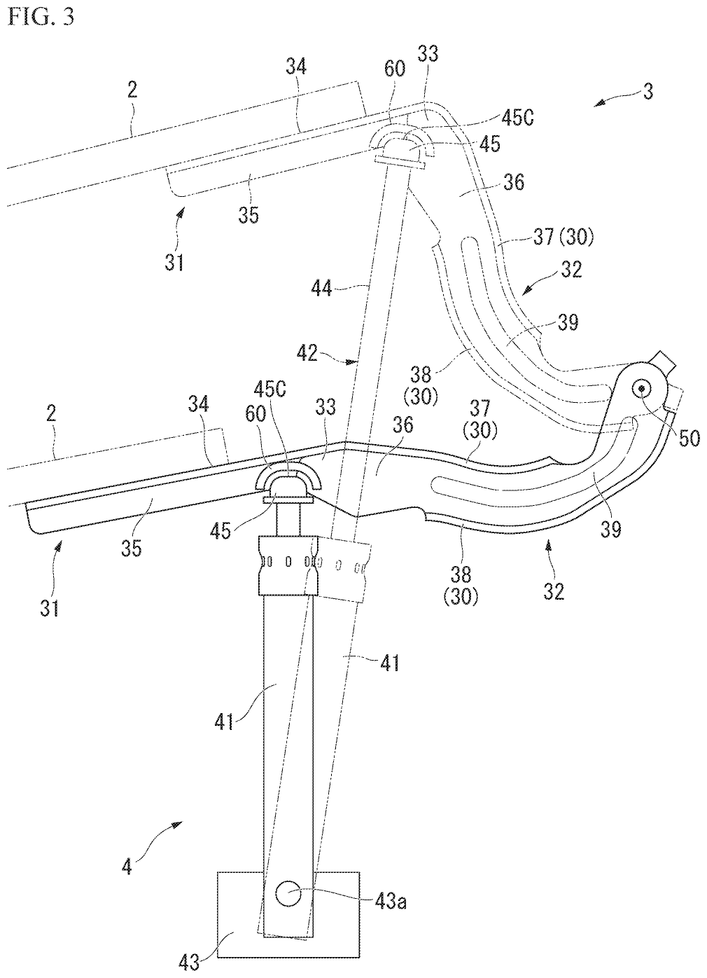

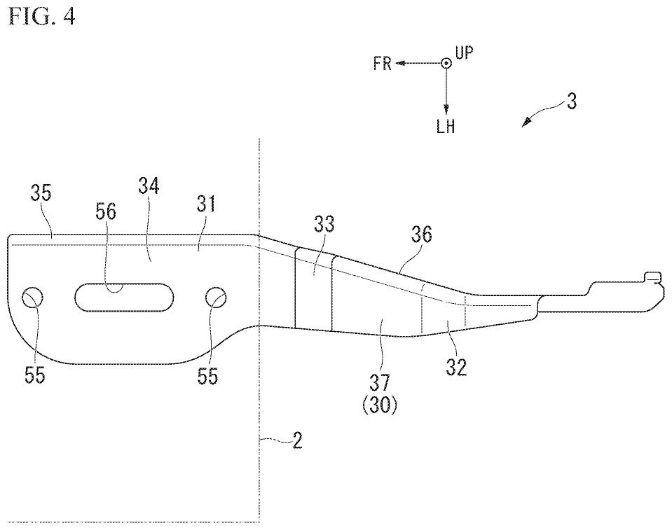

FIG. 3 is a side view of the hinge members 3. In addition, FIG. 4 is a plan view of the hinge members 3 in a first state S1 of FIG. 3.

The hinge members 3 are provided as a pair on left and right sides behind the opening section 10 (see also FIG. 1). Since the pair of hinge members 3 each have the same configuration, the hinge member 3 disposed on the left side will be described in the following description. The hinge members 3 are disposed below the hood 2.

The hinge members 3 connect the vehicle body V and the hood 2. The hinge members 3 are supported pivotably with respect to the vehicle body V. As shown in FIG. 3, the hinge members 3 are pivotable with respect to the vehicle body V between the first state S1 before starting of pivoting and a second state S2 after completion of pivoting.

In the first state S1, the hinge members 3 extend in a forward/rearward direction of the vehicle body V. In the first state S1, the hinge members 3 are accommodated in an engine room E. The hinge members 3 in the second state S2 are disposed above the hinge members 3 in the first state S1.

When the hood support structure 1 is operated, a part of the hinge member 3 is plastically deformed while the hinge member 3 is pivoted with respect to the vehicle body V. Accordingly, the hood 2 is moved upward.

The hinge member 3 has a pedestal section 31, a support section 32 and a deformation section 33.

The pedestal section 31 is disposed along a lower surface of the hood 2. The pedestal section 31 extends in the forward/rearward direction of the vehicle body V. The pedestal section 31 has a placing section 34 and an overhanging section 35.

The placing section 34 is in contact with the lower surface of the hood 2. The placing section 34 is formed in a plate shape.

As shown in FIG. 4, two fastening holes 55 and a weight reducing hole 56 are formed to pass through the placing section 34. The fastening holes 55 are arranged in an extending direction of the hinge member 3 (the forward/rearward direction of the vehicle body V). Bolts (not shown) are inserted into the fastening holes 55, and the hood 2 is fixed to the pedestal section 31 by the bolts.

The overhanging section 35 overhangs downward from an end portion of the placing section 34 inside in the vehicle width direction. The pedestal section 31 is formed in an L-shaped cross section by the placing section 34 and the overhanging section 35.

The support section 32 is provided behind the pedestal section 31. The support section 32 is connected to the pedestal section 31. The support section 32 has a sidewall section 36 and a reinforcement member 30.

The sidewall section 36 is formed in a flat plate shape continuous with the overhanging section 35 of the pedestal section 31. A front end of the sidewall section 36 is connected to a rear end of the overhanging section 35. A bead 39 is formed on the sidewall section 36 in an extending direction of the sidewall section 36. A rotary shaft 50 is provided on a rear end portion of the sidewall section 36. The support section 32 is pivotably attached to the vehicle body V about the rotary shaft 50.

The reinforcement member 30 has an upper wall section 37 and a lower wall section 38.

The upper wall section 37 extends outward from an upper end portion of the sidewall section 36 in the vehicle width direction. A front end of the sidewall section 36 is connected to a rear end of the placing section 34 in the pedestal section 31. The upper wall section 37 is formed in a triangular shape having a width dimension that is reduced from a front end toward a rear end.

The lower wall section 38 extends outward from a lower end portion of the sidewall section 36 in the vehicle width direction. The lower wall section 38 is provided on a lower end portion of the sidewall section 36 at the side of the rotary shaft 50 (a rear side in the forward/rearward direction).

The support section 32 is formed in a U-shaped cross section by the sidewall section 36, the upper wall section 37 and the lower wall section 38.

The deformation section 33 is provided between the pedestal section 31 and the support section 32. The deformation section 33 is formed to have rigidity lower than that of the pedestal section 31 and the support section 32. Specifically, rigidity of the support section 32 is higher than that of the pedestal section 31, and rigidity of the pedestal section 31 is higher than that of the deformation section 33. In the embodiment, the support section 32 has a structure having rigidity higher than that of the pedestal section 31 and the deformation section 33. A receiving section 60 to which a tip portion 45 of the actuator 4 (to be described below) is able to be fit is provided in the deformation section 33.

### (Actuator)

As shown in FIG. 1, the pair of left and right actuators 4 are provided behind the opening section 10. The actuators 4 are supported to be pivotable with respect to the vehicle body V while following movement of the hood 2. Here, since the pair of actuators 4 have the same configuration, the actuator 4 disposed on the left side will be described in the following description.

The actuator 4 has a cylinder 41 and a shaft 42.

The cylinder 41 is formed in a tubular shape. The cylinder 41 is disposed below the hood 2. As shown in FIG. 3, a lower end of the cylinder 41 is connected to a holding member 43. The holding member 43 supports the cylinder 41 with respect to the vehicle body V to be pivotable about a shaft 43a. When the hinge member 3 is in the first state S1, an axial direction of the cylinder 41 crosses an extending direction of the hinge member 3. When the hinge member 3 is in the second state S2, the axial direction of the cylinder 41 is inclined toward a side behind the vehicle body V. An ignition apparatus (not shown) is connected to the cylinder 41. The ignition apparatus ignites an ignition body in the cylinder 41 when an impact load F1 is input to a G sensor.

The shaft 42 is configured to be slidable in the cylinder 41 in the axial direction of the cylinder 41. In the first state S1 before the impact load F1 is input, the shaft 42 is accommodated in the cylinder 41. The shaft 42 has a rod-shaped shaft main body 44, and the tip portion 45 provided on a tip of the shaft main body 44. The tip portion 45 abuts the hinge member 3 when the hood support structure 1 is operated. In the embodiment, the tip portion 45 has a convex surface 45c protruding toward the hinge member 3.

### (Receiving Section)

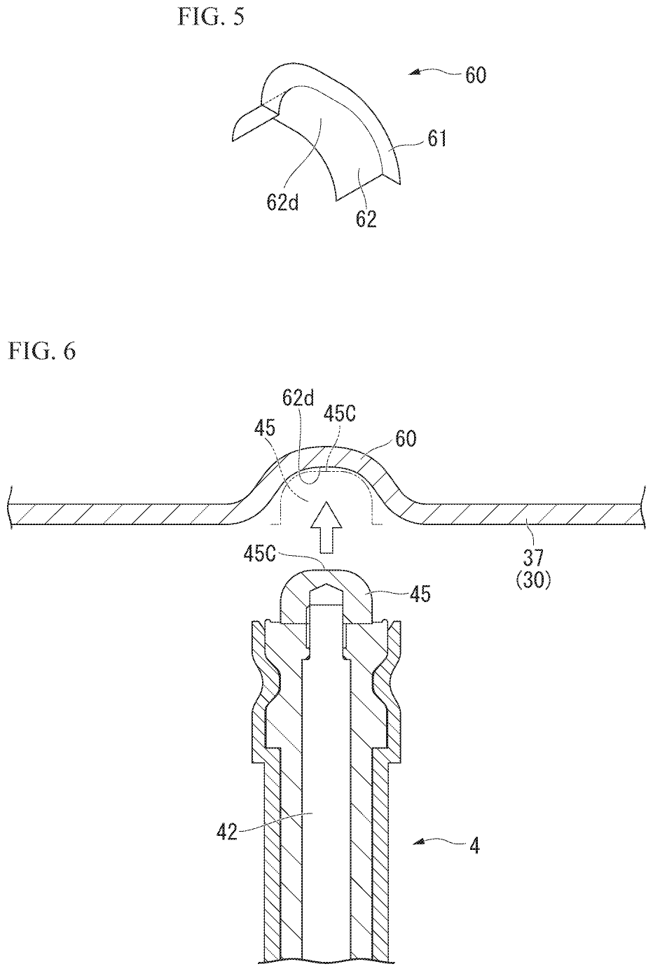

FIG. 5 is a perspective view of the receiving section 60. The receiving section 60 is provided in the vicinity of the deformation section 33 of the hinge member 3. The receiving section 60 has a connecting section 61 and an abutting section 62.

The connecting section 61 is formed in a flat plate shape. The connecting section 61 is joined to the hinge member 3 through welding, caulking, or the like.

The abutting section 62 has a concave surface 62d recessed toward the hood 2. An edge portion of the abutting section 62 in the vehicle width direction is connected to the connecting section 61. The concave surface 62d has a curvature corresponding to the convex surface 45c (see FIG. 3) in the tip portion 45 of the shaft 42. Specifically, a radius of curvature of the concave surface 62d is larger than that of the convex surface 45c.

Next, an operation of the hood support structure 1 will be described.

During normal traveling in which the impact load F1 (see FIG. 2) is not input to the vehicle body V, the hinge members 3 are set to the first state S1 (see FIG. 3). In the first state S1, the pedestal section 31 and the support section 32 extend in the forward/rearward direction. Here, a rear end of the pedestal section 31 and a front end of the support section 32 are connected to each other. In addition, in the first state S1, the hood 2 closes the opening section 10.

When the impact load F1 is input to the vehicle body V, the ignition apparatus receives a signal from the G sensor and ignites the ignition body in the cylinder 41. When the ignition body ignites and a gas in the cylinder 41 expands, the shaft 42 slides out upward in the axial direction. Accordingly, the tip portion 45 of the shaft 42 abuts the receiving section 60, and the hinge member 3 connected to the receiving section 60 is lifted upward. Here, the deformation section 33 is deformed and the hood 2 is lifted up while the hinge member 3 is pivoted upward using the rotary shaft 50 as a rotary center. In addition, here, since the tip portion 45 of the shaft 42 in the actuator 4 is moved while following the receiving section 60, output of the actuator 4 is efficiently transmitted to the hinge member 3, and the hood 2 is reliably moved to a target position. Accordingly, a predetermined gap is secured between the hood 2 and engine parts in the engine room E.

After the hood 2 is moved, when a colliding body collides with the hood 2 from an upper front side of the vehicle body V, a collision load F2 (see FIG. 2) is input to an upper surface of the hood 2. The colliding body that collides with the hood 2 is gradually decelerated while deforming the hood 2. When the collision load F2 is large, the colliding body is decelerated while deforming the hinge member 3 in addition to the hood 2. In this way, the collision load F2 is absorbed by deformation of the hood 2, the hinge member 3, or the like. Accordingly, a reaction received by the colliding body from the vehicle body V is reduced.

### (Action and Effect)

Next, an action and an effect of the hood support structure 1 will be described. According to the hood support structure 1 of the embodiment, the hood 2 is moved upward as the actuators 4 abut the hinge members 3. Accordingly, since there is a cavity between the hood 2 and the engine parts provided in the front section of the vehicle body V, when the colliding body collides from the front section of the vehicle body V, the collision load F2 of the colliding body input to the vehicle body V can be absorbed by deformation of the hood 2. Here, the hinge member 3 moves the hood 2 upward as the deformation section 33 is deformed while being pivoted upward by the actuator 4. Since the tip portion 45 of the shaft 42 abuts the deformation section 33 of the hinge member 3, input from the actuator 4 can be concentrated to a deformation center, and the deformation section 33 can be reliably deformed. Accordingly, a moving amount of the hood 2 can be accurately controlled with respect to a target value.

Since the receiving section 60 is provided in the deformation section 33, an abutting position between the tip portion 45 of the actuator 4 during extension and the hinge member 3 that is pivoted can be constantly maintained by fitting the tip portion 45 of the shaft 42 into the receiving section 60. Accordingly, occurrence of friction can be minimized due to sliding of the tip portion 45 of the shaft 42 through the hinge member 3, and output of the shaft 42 can be efficiently transmitted to the deformation section 33.

Accordingly, it is possible to provide the hood support structure 1 capable of stabilizing deformation of the hinge member 3 and reliably operating the hood 2.

Further, since output of the actuator 4 can be efficiently converted into deformation of the deformation section 33, output of the actuator 4 can be minimized. Accordingly, saving of energy and reduction of costs can be achieved due to reduction in size and a decrease in output of the actuator 4.

According to the hood support structure 1 of the embodiment, the receiving section 60 is formed by providing a plate member on the deformation section 33, and rigidity of the receiving section 60 is higher than that of the deformation section 33. Accordingly, a force from the actuator 4 is reliably received by the receiving section 60, and output of the actuator 4 can be efficiently transmitted to the deformation section 33.

Accordingly, it is possible to provide the hood support structure 1 capable of stabilizing deformation of the hinge member 3 and reliably operating the hood 2.

The tip portion 45 of the shaft 42 has the convex surface 45c, and the receiving section 60 has the concave surface 62d.

The abutting position between the tip portion 45 of the shaft 42 and the receiving section 60 can be constantly held by fitting the convex surface 45c and the concave surface 62d to each other. Accordingly, the tip portion 45 of the shaft 42 can reliably follow the hinge member 3 that is pivoted, and the hood 2 can be reliably moved to a target position of the hood 2.

Since the actuator 4 is supported pivotably with respect to the vehicle body V, the actuator 4 is inclined rearward while following movement of the hood 2. Accordingly, even in pivoting of the hinge member 3, the receiving section 60 can reliably abut the tip portion 45 of the shaft 42. In addition, since the actuator 4 is also pivoted while following rearward movement of the receiving section 60, deformation of the shaft 42 can be minimized. Accordingly, output of the actuator 4 can be stably transmitted to the deformation section 33, and the hood 2 can be reliably operated.

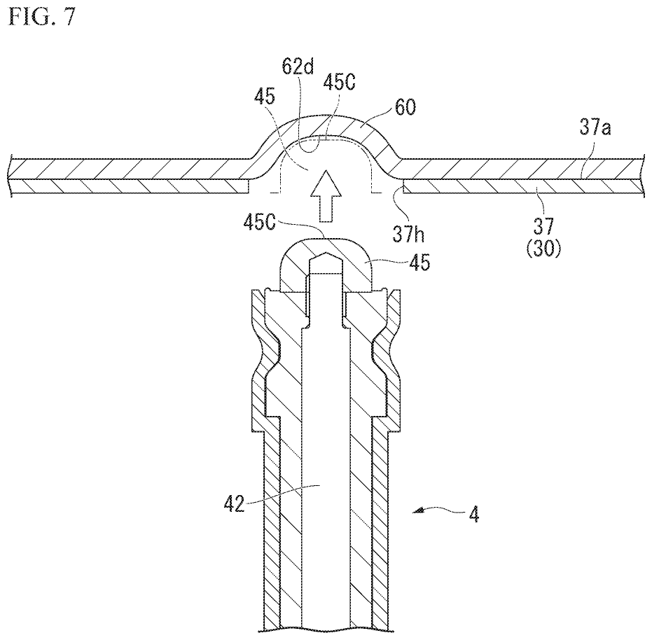

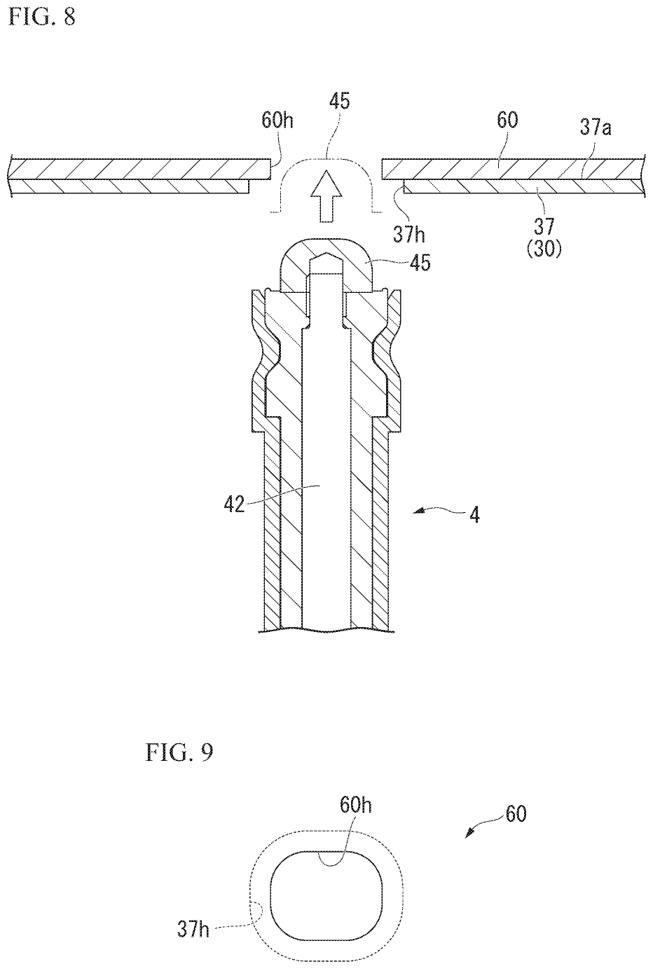

Next, a first variant of the first embodiment and a second variant of the first embodiment will be described with reference to FIG. 6 and FIG. 7. In addition, a second embodiment, a first variant of the second embodiment and a second variant of the second embodiment will be described with reference to FIG. 8 to FIG. 11. Further, the same or similar members in the variants and the second embodiment as or to those in the above-mentioned embodiment are designated by the same reference numerals and detailed description thereof will be omitted. In the following description, reference numerals related to configurations other than those disclosed in FIG. 6 to FIG. 11 will be appropriately referred to as those in FIG. 1 to FIG. 5.

### First Variant of First Embodiment

FIG. 6 is a cross-sectional view of the receiving section 60 according to a first variant of the first embodiment. The embodiment is distinguished from the above-mentioned embodiment in that the receiving section 60 is provided integrally with the hinge member 3.

In the embodiment, the receiving section 60 is formed integrally with the upper wall section 37 (the reinforcement member 30). Specifically, the upper wall section 37 is curved to protrude toward the hood 2 at a position corresponding to the tip portion 45 of the shaft 42. A curved portion in the upper wall section 37 becomes the receiving section 60. The receiving section 60 is formed to have rigidity higher than that of the deformation section 33 (see FIG. 3). The receiving section 60 has the concave surface 62d facing the actuator 4.

A radius of curvature of the concave surface 62d is larger than that of the convex surface 45c in the tip portion 45 of the shaft 42.

According to the hood support structure 1 of the first variant, since the receiving section 60 is provided integrally with the hinge member 3, the number of parts can be reduced in comparison with the case in which the receiving section 60 is configured as a separate member. In addition, since rigidity of the receiving section 60 is higher than that of the deformation section, a force from the actuator 4 can be reliably received by the receiving section 60, and output of the actuator 4 can be efficiently transmitted to the deformation section 33 (see FIG. 3).

Accordingly, the hood 2 can be reliably operated by the simple configuration.

### Second Variant of First Embodiment

FIG. 7 is a cross-sectional view of the receiving section 60 according to a second variant of the first embodiment. The embodiment is distinguished from the above-mentioned embodiment in that the receiving section 60 is provided in the upper wall section 37 (the reinforcement member 30) of the hinge member 3.

In the embodiment, a punched hole 37h is formed in the upper wall section 37 (the reinforcement member 30) at a position corresponding to the tip portion 45 of the shaft 42. An inner diameter of the punched hole 37h is larger than an outer diameter of the tip portion 45 of the shaft 42. The receiving section 60 is provided in an upper surface 37a of the upper wall section 37 at a position corresponding to the punched hole 37h. The receiving section 60 is formed by a plate member curved to protrude upward at a position corresponding to the punched hole 37h.

According to the hood support structure 1 of the second variant of the first embodiment, the receiving section 60 can be provided by attaching the curved plate member to the upper wall section 37 (the reinforcement member 30). Accordingly, the receiving section 60 can be disposed by a simple method.

Further, like the first embodiment, the receiving section 60 may have a configuration in which the receiving section 60 includes the connecting section 61, and the receiving section 60 is joined to the hinge member 3 by the connecting section 61.

### Second Embodiment

FIG. 8 is a cross-sectional view of a receiving section 60 according to a second embodiment. FIG. 9 is a plan view of the receiving section 60 according to the second embodiment. The embodiment is distinguished from the above-mentioned embodiment in that a hole 60h is formed as the receiving section 60.

In the embodiment, the punched hole 37h is formed in the upper wall section 37 (the reinforcement member 30) at a position corresponding to the tip portion 45 of the shaft 42. An inner diameter of the punched hole 37h is larger than an outer diameter of the tip portion 45 of the shaft 42. The receiving section 60 is provided in the upper surface 37a of the upper wall section 37 at a position corresponding to the punched hole 37h. The receiving section 60 is formed in a flat plate shape. The hole 60h is formed in the receiving section 60 at a position corresponding to the punched hole 37h. As shown in FIG. 9, the hole 60h is a long hole having a major axis in a forward/rearward direction of the vehicle body V. The tip portion 45 of the shaft 42 enters the hole 60h.

According to the hood support structure 1 of the second embodiment, the tip portion 45 of the shaft 42 can be received by fitting the tip portion 45 of the shaft 42 into the hole 60h of the receiving section 60. In this way, since the receiving section 60 is provided by a simple configuration, it is possible to provide the hood support structure 1 capable of facilitating machining of the receiving section 60 during manufacturing.

Further, the hole 60h of the receiving section 60 is a long hole, and a major axis of the long hole is formed in the forward/rearward direction of the vehicle body V. Accordingly, in comparison with the case in which the receiving section 60 is formed by the hole 60h having a circular shape, slippage between the tip portion 45 of the shaft 42 and the receiving section 60 is allowed which is caused by the pivoting of the hinge member 3 and the movement of the deformation section 33 in the forward/rearward direction. Accordingly, removal of the tip portion 45 of the shaft 42 from the hinge member 3 during pivoting of the hinge member 3 can be minimized. Accordingly, output of the actuator 4 can be stably transmitted to the deformation section 33.

Further, the receiving section 60 may be formed by a plurality of (two or more) flat plates. In addition, the receiving section 60 may be provided on the placing section 34 of the pedestal section 31. A shape of the hole 60h may be an elliptical shape, a rectangular shape, or the like.

### First Variant of Second Embodiment

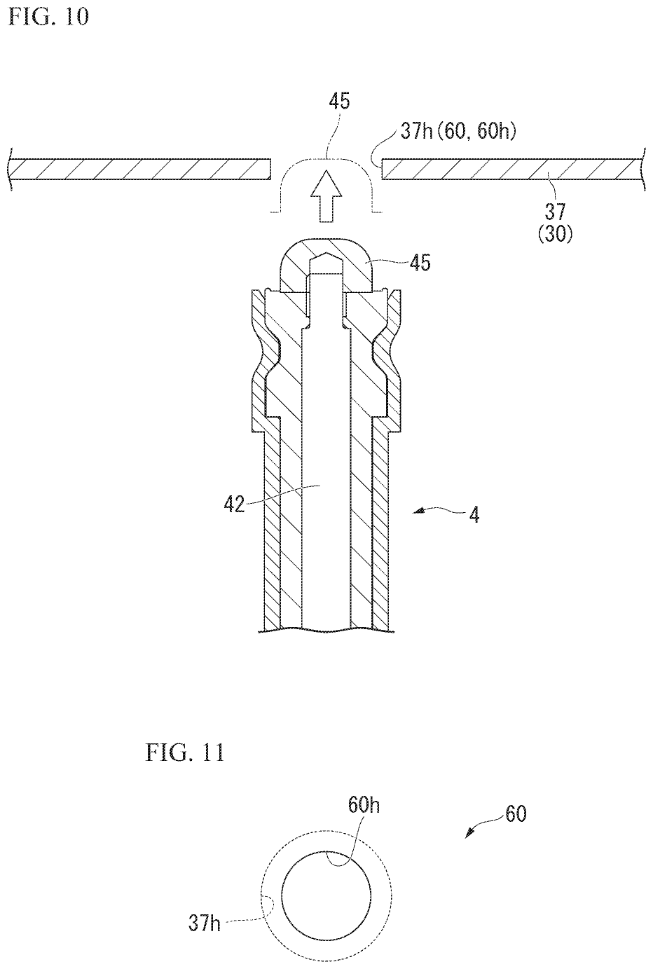

FIG. 10 is a cross-sectional view of a receiving section 60 according to a first variant of the second embodiment. The embodiment is distinguished from the above-mentioned embodiment in that the hole 60h is formed as the receiving section 60 and the receiving section 60 is provided integrally with the hinge member 3.

In the embodiment, the receiving section 60 is formed integrally with the upper wall section 37 (the reinforcement member 30). Specifically, the punched hole 37h is formed in the upper wall section 37 at a position corresponding to the tip portion 45 of the shaft 42. The tip portion 45 of the shaft 42 enters the punched hole 37h. In other words, the punched hole 37h becomes the hole 60h of the receiving section 60.

According to the hood support structure 1 of the first variant of the second embodiment, the receiving section 60 can be formed by forming the punched hole 37h in the upper wall section 37 (the reinforcement member 30). Accordingly, the receiving section 60 can be formed through a simpler method.

### Second Variant of Second Embodiment

FIG. 11 is a plan view of a receiving section 60 according to a second variant of the second embodiment. The embodiment is distinguished from the above-mentioned embodiment in that the hole 60h of the receiving section 60 is formed in a perfect circular shape.

In the embodiment, the punched hole 37h is formed in the upper wall section 37 (the reinforcement member 30) at a position corresponding to the tip portion 45 of the shaft 42 (see FIG. 8). The punched hole 37h is formed in a perfect circular shape. An inner diameter of the punched hole 37h is larger than an outer diameter of the tip portion 45 of the shaft 42. The receiving section 60 is provided on the upper surface 37a of the upper wall section 37 at a position corresponding to the punched hole 37h. The receiving section 60 is formed in a flat plate shape. The hole 60h is formed in the receiving section 60 at a position corresponding to the punched hole 37h. As shown in FIG. 11, the hole 60h is formed to become a perfect circle. The tip portion 45 of the shaft 42 enters the hole 60h.

According to the hood support structure 1 of the second variant of the second embodiment, since the hole 60h is formed to become a perfect circle, the tip portion 45 of the shaft 42 is reliably fitted into the hole 60h. Accordingly, a variation in relative position between the hinge member 3 and the tip portion 45 of the shaft 42 can be minimized.

Accordingly, a force from the actuator 4 can be reliably received by the receiving section 60, and output of the actuator 4 can be more efficiently transmitted to the deformation section 33 (see FIG. 3).

Further, the technical scope of the present invention is not limited to the above-mentioned embodiments, and various modifications may be added without departing from the scope of the present invention.

For example, while the configuration in which the support section 32 has the reinforcement member 30 and formed of a material having higher rigidity than that of the pedestal section 31 and the deformation section 33 has been described in the above-mentioned embodiments, there is no limitation thereto. Rigidity of the support section 32 may be increased by only providing the reinforcement member 30 without changing the material of the support section 32. In addition, rigidity of the support section 32 may be increased by only changing a material without providing the reinforcement member 30.

The number of the fastening holes 55 formed in the pedestal section 31 of the hinge member 3 is not limited to two of the embodiment. While the configuration in which the hood 2 is fixed to the fastening holes 55 of the pedestal section 31 by bolts has been described in the embodiment, for example, the hood may be fixed by another method such as adhesion, welding, caulking, or the like. In this case, the fastening holes 55 may not be provided.

In addition, a notch or a hole may be formed in the deformation section 33. That is, while the configuration in which the deformation section 33 is easily deformed by increasing rigidity of the pedestal section 31 and the support section 32 to be higher than that of the deformation section 33 has been described in the embodiment, there is no limitation thereto. A configuration in which the deformation section 33 is made to be fragile than the pedestal section 31 and the support section 32 by providing a fragile section such as a notch, a hole, or the like, in the deformation section 33 and thereby, the deformation section 33 is made to be easily deformed by the fragile section may be provided.

The overhanging section 35 of the hinge member 3 may be formed to overhang downward from an end portion of the placing section 34 outside in the vehicle width direction. Further, the upper wall section 37 and the lower wall section 38 may extend inward in the vehicle width direction with respect to the sidewall section 36.

The actuator 4 may be inclined toward a side behind the vehicle body V in an initial state before extension. In addition, the actuator 4 may be fixed such that inclination before and after movement of the hood 2 is constant. In this case, it is preferable that the relative position between the receiving section 60 and the tip portion 45 of the actuator 4 is not shifted by pivoting of the hinge member 3. That is, for example, the hinge member 3 may be configured to be deformable such that a positional variation in the forward/rearward direction due to pivoting of the hinge member 3 is offset.

A shape of the tip portion 45 of the actuator 4 may be a trigonal pyramid shape, a quadrangular pyramid shape, a truncated conical shape, or the like. In this case, a shape of the receiving section 60 may be formed to become a shape corresponding to the shape of the tip portion 45.

A configuration in which an impact load F1 is detected by a method such as a camera, an infrared laser, or the like, other than the G sensor with respect to the impact load F1 from a side in front of the vehicle body, may be provided.

In the hood support structure 1, while the configuration in which the entire hood 2 is moved upward and rearward with respect to the vehicle body V has been described in the embodiment, there is no limitation thereto. For example, the hood support structure 1 having a configuration in which only a rear side of the hood 2 is lifted to above the vehicle body may be provided.

In addition, the hood support structure 1 may be applied to a trunk hood behind the vehicle body V or another hood. The hood support structure 1 of the present invention may be widely applied to another vehicle V including an energy storage such as a hybrid automobile, an electric automobile, a fuel cell automobile or the like. While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A hood support structure comprising:
a hood configured to close an opening section of a vehicle body;
a hinge member that includes a pedestal section fixed to a lower surface of the hood, a support section attached pivotably with respect to the vehicle body, and a deformation section which is provided between the pedestal section and the support section and which is fragile than the pedestal section and the support section; and
an actuator that has a shaft configured to slide out in a predetermined direction, and that is configured to move the hood upward from the opening section by abutting a tip portion of the shaft with the deformation section,
wherein a receiving section into which the tip portion of the shaft enters is provided in the deformation section.

2. The hood support structure according to claim 1, wherein the receiving section is a plate member provided to overlap the deformation section on the side of the hood, and
rigidity of the receiving section is higher than rigidity of the deformation section.

3. The hood support structure according to claim 1, wherein the receiving section is provided integrally with the hinge member, and
rigidity of the receiving section is higher than rigidity of the deformation section.

4. The hood support structure according to claim 1, wherein the tip portion of the shaft has a convex surface, and
the receiving section has a concave surface having a curvature corresponding to the tip portion of the shaft and recessed toward the hood.

5. The hood support structure according to claim 1, wherein a hole into which the tip portion of the shaft enters is formed in the receiving section.

6. The hood support structure according to claim 5, wherein the hole is a long hole having a major axis in a forward/rearward direction of the vehicle body.

7. The hood support structure according to claim 5, wherein the hole is formed as a perfect circle.

8. The hood support structure according to claim 1, wherein the actuator is supported pivotably with respect to the vehicle body while following movement of the hood.
